(19) United States
(12) Patent Application Publication
(10) Pub. No.: US 2010/0162122 A1
(43) Pub. Date: Jun. 24, 2010

(54) Method and System for Playing a Sound Clip During a Teleconference

(75) Inventors: Jeffrey Mikan, Atlanta, GA (US); Justin McNamara, Atlanta, GA (US); John Lewis, Lawrenceville, GA (US); Fulvio Cenciarelli, Suwanee, GA (US)

Correspondence Address: AT&T Legal Department - WW, Patent Docketing Room 2A-207, One AT&T Way, Bedminster, NJ, 07921, US

(73) Assignee: AT&T Mobility II LLC, Atlanta, GA (US)

(21) Appl. No.: 12/342,540

(22) Filed: Dec. 23, 2008

(51) Int. Cl. G06F 3/16

(52) U.S. Cl. 715/727; 711/100; 715/751

(57) ABSTRACT

A system, method, and device for playing a sound clip during a teleconference. The method includes recording or otherwise obtaining a sound clip, storing the sound clip, associating the sound clip to a corresponding activation code, associating a description or identifier to each sound clip, selecting the sound clip to be replayed, and playing the sound clip during a teleconference, while the user is on mute, by entering a corresponding activation code into a user interface.

### TECHNICAL FIELD

The present invention relates generally to the field of telecommunications and specifically to playing a sound clip during a teleconference.

### BACKGROUND

As mobile phone use and telecommunication becomes increasingly prevalent in modern culture, people often answer and place phone calls from a variety of different locations. People may use mobile phones while driving in the car, waiting in the airport, or in any other loud, noisy environment. Because a user may not always be able to find a quiet place to talk outside of the office or home, the person(s) on the other end of the conversation may be unable to hear the user clearly, or even at all. For example, if a business professional is forced to take a conference call while waiting for a flight in an airport, the other participants of the conference call may not be able to hear the business professional's comments due to the loud background noise. Additionally, such background noise may also be disruptive to the participants of the conference call.

Being on a call in a loud environment may also lead to inefficient communication, or even worse, miscommunication. For example, during an important budgeting conference call, the other participants may be forced to ask a user, located in a loud environment, to constantly repeat him/herself as a result of the background noise. This leads to wasted time and productivity. Even worse, during the same budgeting call, the other participants of the call may mishear a user's words leading to potentially bigger problems.

A decrease in personal privacy is another issue that arises with the increase in mobile phone use and telecommunication. With the ease of accessibility currently available, sometimes people simply want avoid disclosing their location. For example, if a user's child has an important ceremony that the user must attend, however, the office simultaneously schedules an important conference call, then the user can still participate in the conference call without disclosing his/her location.

In an age of mobile phones and increased accessibility, another issue that may arise is when people on phones are disruptive to those around them, especially in quiet areas. In the previous example, if a user answers the call during the ceremony, although other participants of the conference call may be able to hear the user, the user will disrupt those seated around him/her.

Additionally, people increasingly strive for customization as well as new ways to express themselves. For example, sometimes on the telephone a user may be at a loss for words or mere words may not be able to clearly convey certain emotions.

As a result, designers of telecommunications operations are constantly looking for new ways to allow users to express themselves as well as new ways to minimize the amount of noise generated by a telecommunications device user and minimize the amount of background noise during telecommunications.

### SUMMARY

The present invention provides a method, system, and device for playing a sound clip during a teleconference. Teleconferencing can be by a voice and/or video arrangement. Additionally, teleconferencing can be between two or more people, or between one person and a machine. To playback sound clips during a teleconference, a user pre-records one or more sound clips or obtains one or more pre-recorded sound clips and activates the sound clips by inputting a corresponding activation code into a user interface rather than actually speaking in real time during the teleconference, while the user's device is muted. For example, if a user has a conference call scheduled while s/he will be traveling and located in a noisy airport, the user may pre-record sound clips with responses to anticipated questions. The user, then, associates a corresponding activation signal, such as a Dual Tone Multi Frequency tone, to each pre-recorded sound clip. Therefore, during the conference call, the user may place his/her device on mute yet still participate in the call and be clearly understood, without disrupting the call or revealing the user's location, by simply inputting the corresponding activation code wherein the sound clip is replayed on the call.

Further, the user may save a plurality of sound clips under different profiles to be directed to specific teleconferences. For example, a user can save sound clips of responses to questions expected in a conference call with the office under a particular profile titled “Office Conference Call.” Similarly, on the same storage medium, the user may also have a separate profile titled “Information for Spouse,” where a user stores sound clips of responses directed to the user's spouse.

In one exemplary embodiment, a method is described in which a user pre-records a sound clip or plurality of sound clips and saves them on a storage medium. The user then associates each sound clip with a corresponding activation code. Therefore, during a teleconference, the user may activate the sound clips by inputting the corresponding activation signal into a user interface.

### BRIEF DESCRIPTION OF THE DRAWINGS

The foregoing summary, as well as the following detailed description of illustrative embodiments, is better understood when read in conjunction with the appended drawings. For purposes of illustrating the invention, there is shown in the drawings example constructions of the invention; however, the invention is not limited to the specific methods and instrumentalities disclosed.

FIG. 1 is a block diagram of non-limiting, exemplary wireless devices and wireless communication network.

FIG. 2 is a block diagram of a non-limiting, exemplary system for playing a sound clip during a teleconference.

FIG. 3 is a flowchart of a non-limiting, exemplary method of playing a sound clip during a teleconference.

FIG. 4 is a flowchart of a non-limiting, exemplary method for enabling a user to play a sound clip during a teleconference.

FIG. 5 is a block diagram of a non-limiting, exemplary device that may be used in connection with an embodiment.

### DETAILED DESCRIPTION OF ILLUSTRATIVE EMBODIMENTS

The subject matter of the various embodiments is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Additionally, it should be understood that the following embodiments may be performed by hardware, software or client, or a combination of both. Moreover, although the term “step” may be used herein to connote different aspects of methods employed, the term should not be interpreted as implying any particular order among or between various steps herein disclosed unless and except when the order of individual steps is explicitly described. The following description is illustrative and non-limiting to any one aspect.

Modem communications devices allow people to communicate with one another through many different channels. Standard home telephones, office telephones, mobile telephones, and other mobile devices, and the various types of computers and computing devices provide a user with a plethora of communication options. With the increasing use of such devices, people have correspondingly become increasingly accessible. As a result, people can be reached and also attempt to communicate from a variety of locations. However, this can create a problem when a user is trying to converse from a noisy or, a commonly expected, quiet location.

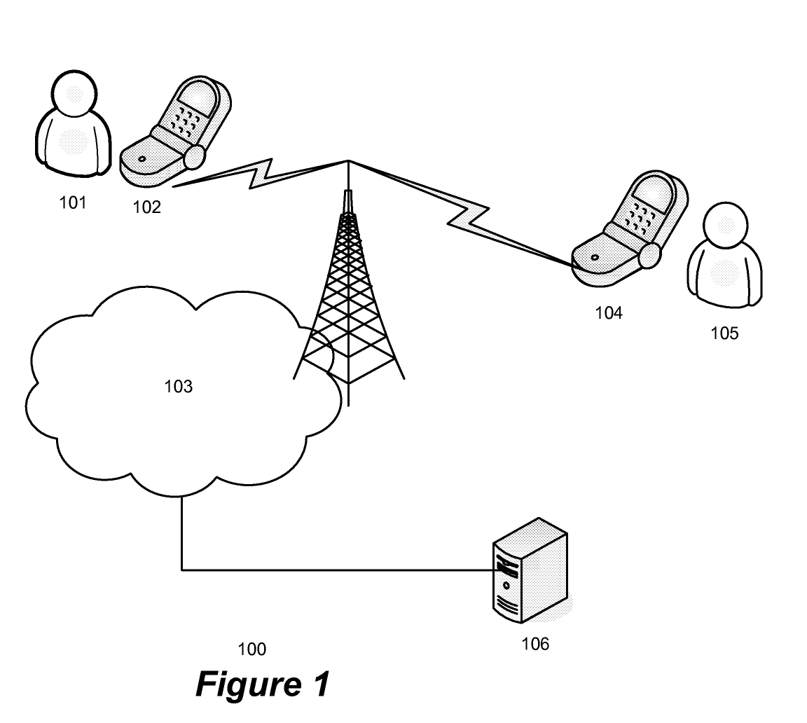

FIG. 1 illustrates a system 100 including devices and a preferred network. When user 101 desires to communicate with another user 105, user 101 may operate device 102. Device 102 and 104 may be any device capable of communicating via a preferred cellular network, including, but not limited to, a mobile telephone, personal data assistant (PDA), laptop, desktop, or any other type of device. Device 102 may be able to communicate with other devices, such as device 104, using a network 103. As known by those skilled in the art, network 103 is a preferred cellular operating environment capable of connecting two or more mobile devices. Additionally, connected to network 103 is a sound clip recording server 106. The sound clip recording server 106 may be a component, system, or subsystem of network 103, or sound clip recording server 106 may be owned, operated, and/or under the control of a third party.

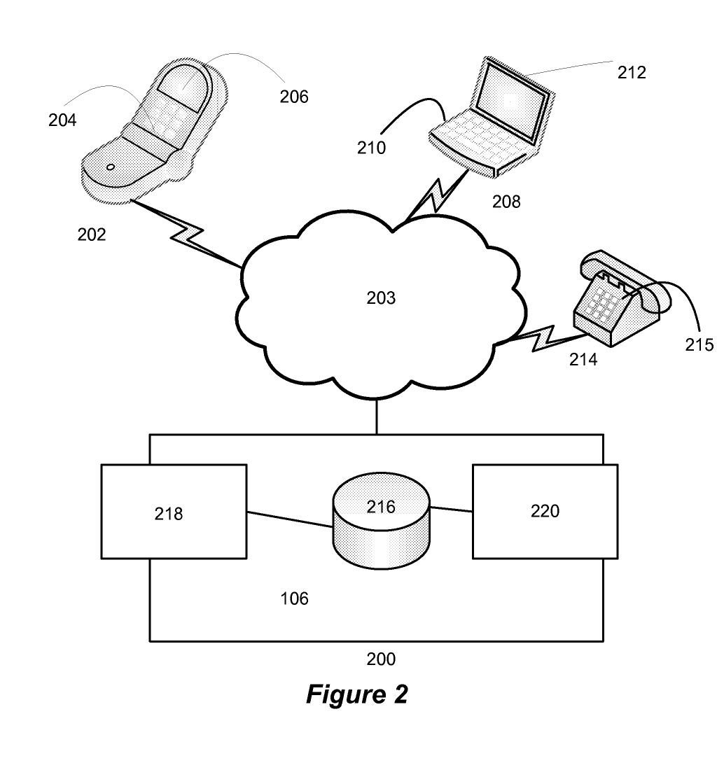

FIG. 2 illustrates a sound clip recording system 200 for replaying sound clips during a teleconference. A sound clip may be a pre-recorded voice clip, a pre-recorded noise, a sound effect, musical notes, musical lyrics, readings of famous quotes, famous movie quotes, pre-recorded voice bits pulled together to generate a word, or the like. Additionally, a teleconference may be between two or more persons or between one person and a machine. When a user wishes to engage in a teleconference, the user may utilize device 202, 208, or 214 in order to connect to a communication network 203. Device 202, 208 and 214 may be any device capable of communicating via a communication network 203 including, but not limited to, a land line telephone, mobile telephone, personal data assistant (PDA), laptop, desktop, or any other type of device capable of connecting to a communication network. Additionally, the communication network 203 may be any network capable of allowing communication between two or more persons including, but not limited to, a cellular network, Internet network, Public Switched Telephone Network (PTSN), and the like. Utilizing network 203, device 202 may be able to communicate with other devices, such as device 208 and device 214.

Devices 202, 208, and 214 may also be capable of connecting to the sound clip recording server 106 which is connected to the communication network 203. The sound clip recording server 106 may be a component, system, or subsystem of communication network 203, or the sound clip recording server 106 may be owned, operated, and/or under the control of a third party. Additionally, in one embodiment, the sound clip recording server 106 is additionally comprised of a recording device 220, storage medium 216, and processor 218.

The recording device 220 is configured to allow a user to record one or more sound clips. Recording device 220 includes any device capable of performing sound recording capabilities. In one embodiment, the recording device 220 is located within and connected to communication network 203 through sound clip recording server 106. Additionally, recording device 220 may be controlled through user interfaces 204, 210, and 215 on devices 202, 210, and 214, respectively. The recording device 220 is also configured to allow a user to listen to a sound clip, delete a recorded sound clip, and record over an existing sound clip at any time. In an alternative embodiment, recording device 220 may be externally located in relation to sound clip recording server 106 and connected to communication network 203 via other means. Additionally, in another alternative embodiment, the recording device 220 may be controlled without utilizing a user interfaces 204, 210, or 215.

Additionally, recording device 220 is also connected to a storage medium 216. In one embodiment, storage medium 216 is configured to allow a user to store sound clips. As will be discussed in greater detail below, each sound clip may be directed to a specified teleconference. In one embodiment, storage medium 216 acts like a database and allows users to store the sound clips in profiles, created and stored on storage medium 216, that are directed to a particular teleconference. In another embodiment, storage medium 216 may simply allow a user to store sound clips, that may or may not be directed to a specified teleconference, without the use of profiles. Storage medium 216 includes, but is not limited to, a random access memory (RAM), an SD card, a microSD card, a hard disk, a flash memory, a Compact Disc, a Digital Versatile Disc, and the like. In an alternate embodiment, storage medium 216 may be independent from sound clip recording server 106 and connected to communication network 203 via other means.

In one embodiment, the storage medium 216 is additionally connected to processor 218. Processor 218 is configured to allow a user to associate each sound clip with a corresponding activation code. Processor 218 may be any device configured to associate a sound clip with a corresponding activation code. In another embodiment, processor 218 is also configured to allow a user to associate each sound clip with an identifier. The identifier allows a user to view or verify the content of a particular sound clip. An identifier may include, but is not limited to, a symbol, an abbreviation, a description, a word, and the like. Processor 218 may also be any device configured to associate sound clips with an identifier. Additionally, processor 218 is also configured to replay the sound clip during a teleconference when the corresponding activation code is entered using user interface 204, 210, or 215. Processor 218 may also be configured to operate software, or client, that has text to voice features. User interfaces 204, 210, and 215 include, but are not limited to, a keyboard, a touch activated screen, a voice command processor, a microphone, or an apparatus configured to allow input of a corresponding activation signal.

Additionally, in system 200, devices 202 and 208 comprise display 206 and display 212 which are configured to allow a user to view the description or identifier of each sound clip prior to instructing a device to play the sound clip during a teleconference. Display 206 and display 212 include, but are not limited to, a screen, a monitor, a television, or any other device configured to allow a user to view the identifier or description of each sound clip prior to instructing a device to play them during a teleconference. In an alternate embodiment, devices 202, 208, and 214 allow a user to replay a sound clip, audible only to the user, prior to instructing a device to play the sound clip during a teleconference.

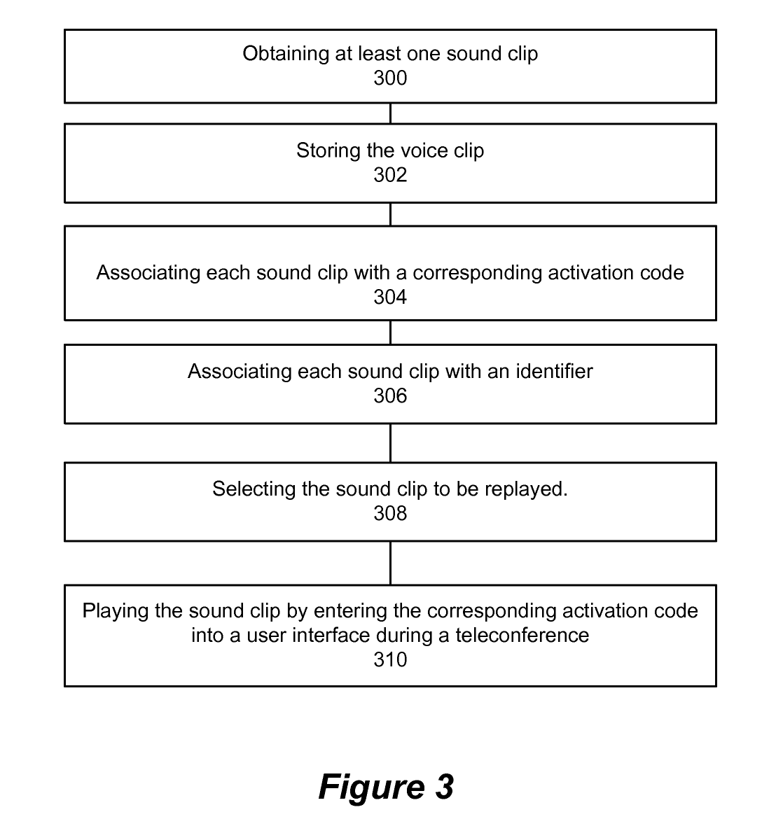

FIG. 3 depicts a flow chart of an exemplary method for playing a sound clip during a teleconference. In one embodiment, a user obtains one or more sound clips at step 300. In one embodiment, a user may record sound clips. A user decides the content of the sound clips based on anticipated questions during a teleconference, standard response phrases, information a user would like for other parties of the teleconference to know, quotes a user likes, sounds a user likes, and the like. The user may also record sound clips for any other additional reason as well. For example, if during a teleconference, a user expects to be asked numerous questions involving yes or no answers, the user may record a sound clip of “Yes” and a sound clip of “No.” As another example, if a user expects his/her spouse to call during a loud dinner meeting, the user may record a sound clip with the relevant information. Additionally, at step 300, the user may also edit the sound clips. A user may replay the sound clip, decide if the sound clip is satisfactory, delete the sound clip, and re-record the sound clip. In another embodiment, the user may edit the sound clip at any time during the method in FIG. 3.

Additionally, in an alternate embodiment, the user may also download, create, splice or otherwise obtain a sound clip. In an alternate embodiment, instead of a user recording one or more sound clips, the user may select from a list of additional third-party pre-recorded sound clips These additional sound clips may be available for free download or purchase and stored in a storage medium, such as storage medium 216. For example, a user may decide s/he likes a particular sound effect or a particular quote from a movie, for instance “I'll be back” from The Terminator. The user decides that s/he wants to use the sound effect or movie quote during a teleconference. The user may then, using a communication network, download the sound clip “I'll be back” from a server. Once a user has obtained a sound clip, the sound clip needs a location to be stored.

At step 302, the sound clips are stored onto storage medium 216. In one embodiment, the obtained sound clips may be stored directly onto the storage medium 216. For example, once the user records a sound clip, s/he may store it directly onto storage medium 216. Additionally, once the user downloads, creates, splices, or otherwise obtains a sound clip, s/he may also store it on storage medium 216. Alternatively, in another embodiment, profiles may be created in which to store sound clips directed towards a specified teleconference. As discussed above, the profiles are created and stored on storage medium 216, and the user may create one or a plurality of profiles in which to store the various sound clips. In one embodiment, each profile is directed to a specific teleconference and associated with a corresponding telephone number, and, therefore, contains sound clip(s) that are also directed to the same specific teleconference. For example, if a user has a teleconference scheduled with “Client X,” the user may create a profile for “Client X,” associated with a corresponding telephone number, on the storage medium 216 and store all sound clips directed to “Client X” in the “Client X” profile. In an alternate embodiment, the profile may be generic and not directed to any specific teleconference; therefore, a user could use the profile on all teleconferences.

Once stored, the user at any time may continually access and edit the sound clips. For example, if the user pre-records a sound clip one week prior to the scheduled teleconference, the user may continually edit or playback the sound clip. Additionally, the user may continually delete sound clips from or add sound clips directly to storage medium 216 or to the profiles in the storage medium 216.

At step 304, the user associates each sound clip with a corresponding activation code. A corresponding activation code may include, but is not limited to, a Dual Tone Multi Frequency tone, a Session Initiated Protocol message, a voice command, a text command, a code, or a combination thereof. As known to one skilled in the art, Dual Tone Multi Frequency is an international signaling standard for touch tone phones. The Dual Tone Multi Frequency generator generates standard telephone digits as the sum of sinusoids corresponding to a frequency table for each digit. Then, the Dual Tone Multi Frequency decoder will take the digital signal as input and produce the decoded digit. In one embodiment, each sound clip within a profile is programmed to respond to a unique corresponding activation code, allowing the user to know exactly which sound clip will be activated. Alternatively, a user may assign two sound clips the same corresponding activation code if the sound clips are located in separate profiles. For example, if a user has created two profiles “A” and “B,” then the user can associate a corresponding activation code of “#1” with one sound clip from profile “A” and one sound clip from profile “B.” Alternatively, each sound clip may still be assigned a unique corresponding activation code regardless of which profile it is located in. Additionally, the sound clips may be activated, not just during a teleconference, but at any time the user wishes to test the functionality of the sound clips by entering the corresponding activation code.

At step 306, after the sound clips are associated with a corresponding activation code, the sound clips may also be associated with an identifier. The identifier allows a user to verify which sound clip he is instructing the device to play before the user actually instructs the device to play the sound clips during a teleconference. Additionally, identifier allows a user to recognize the content of each sound clip. The identifier may include, but is not limited to, a symbol, an abbreviation, a description, a word, or the like.

At step 308, the user selects the sound clip to be replayed. In one embodiment, the user selects a specific profile created for a designated teleconference prior to engaging in the teleconference. For example, prior to engaging in a teleconference with the office, a user selects the “Office Teleconference” profile. Once a profile is selected and the user is engaged in the teleconference, the user can select the sound clips to be replayed. In an alternate embodiment, the user need not select a profile created for a designated teleconference; instead, a profile can be automatically selected based on the calling or the called number. A profile may be associated with a corresponding teleconference; therefore, when a user dials the teleconference telephone number, the sound clips stored in the corresponding profile are automatically enabled for the user to replay. For example, using the example from above, rather than select the “Office Teleconference” profile, the “Office Teleconference” profile may automatically become active once a user dials the associated telephone number. Additionally, the profile may also automatically become active when an incoming call matches the associated telephone number. In an alternate embodiment, the user need not select a profile directed to a specified teleconference; instead, the user may simply select the sound clips directly.

In yet another embodiment, a user may not need to select a sound clip at all. A downloadable client, or software, may be added to augment the normal telephone call client. The downloadable client may have text to voice features. Additionally, the user may have their vocal patterns recognized by the system, so they can enter a response in near real time. For example, a user using a downloadable client having text to voice features may during a teleconference type a text response. The downloadable client with text to voice features then generates a sound clip of the typed text using the user's own vocal patterns recorded and stored on the system. Thus, the other participants of the teleconference may hear the user's near real time typed response in the user's own voice.

When selecting a sound clip to be replayed at step 308, in one embodiment, a user may first view the identifier of the sound clips on a display such as display 206 and display 212. Alternatively, in another embodiment, a user may also view the content of the sound clips via display 206 or display 212. In case the user forgets which corresponding activation code belongs to which sound clip, the user may use the display to verify the sound clip content prior to selecting it to be replayed. For example, if a user records the sound clip “I don't know” and associates “#1” as the corresponding activation code, then a user can view on a display “#1=I don't know.” Additionally, as another example, if the user again records the sound clip “I don't know” and associates “#1” as the corresponding activation code, but this time also associates an identifier of “IDK” with the sound clip, then a user can view on the display “#1=IDK,” thereby verifying the content of the sound clip.

In an alternate embodiment, a downloadable client or software can be added to augment the service, where the downloadable client is a wrapper for the normal telephone call client or software. Using the downloadable client, when a user selects mute, an option menu will be displayed on a display, such as display 206 and 212. The menu may have the following options:

1—unmute

2—respond with sound clip 1

3—respond with sound clip 2.

This allows the user to view multiple sound clips available to be replayed on the display prior to selecting the sound clip to be replayed. Additionally, the client can translate the users input into various commands, for example but not intending to limit, turn off the local microphone, turn off mute, send the DTMF tones for the sound clip, or turn the mute back on.

Additionally, in an alternate embodiment, the user may actually be logged on separately to the client. For example, the user could be on a browser page where he could mute, unmute, or respond with sound clip separate from their handset.

Alternatively, instead of viewing the content of the sound clip, the user may also listen to the sound clip during a teleconference call prior to selecting it to be replayed. This, again, allows the user to verify the content of the sound clip prior to selecting it to be replayed. Additionally, in one embodiment, while viewing or listening to the sound clip prior to selection, only the user, and not other participants of the conference call, will have the capability to see or hear the content of the sound clip.

After selecting the sound clip to be replayed, the user at step 310 can play the sound clip during a teleconference, while the user is muted, by entering the corresponding activation code into a user interface, such as user interfaces 204, 210, or 215. A user interface includes, but is not limited to, a keyboard, a touch activated screen, a voice command processor, a microphone, or an apparatus configured to allow input of a corresponding activation signal. Additionally, entering the corresponding activation code includes dialing said Dual Tone Multi Frequency tone, sending the Session Initiated Protocol message, speaking a voice command, typing a text command, entering a code, or any combination thereof. At step 310, the user is on mute or some other setting which prevents other parties to the teleconference from hearing noise from the user's input. In an alternate embodiment, at step 310, the user can play the sound clip during a teleconference while in the middle of their conversation, and not on mute.

At step 310, once the user instructs the device to play the sound clip, in one embodiment, all of the participants of the teleconference, including the user, can hear the replayed sound clip. Alternatively, in another embodiment, only specified participants may be able to hear the replayed sound clip. For example, if during a teleconference the user only wants a specified participant to hear the user's sound clip, then the user may direct the sound clip to that specified participant.

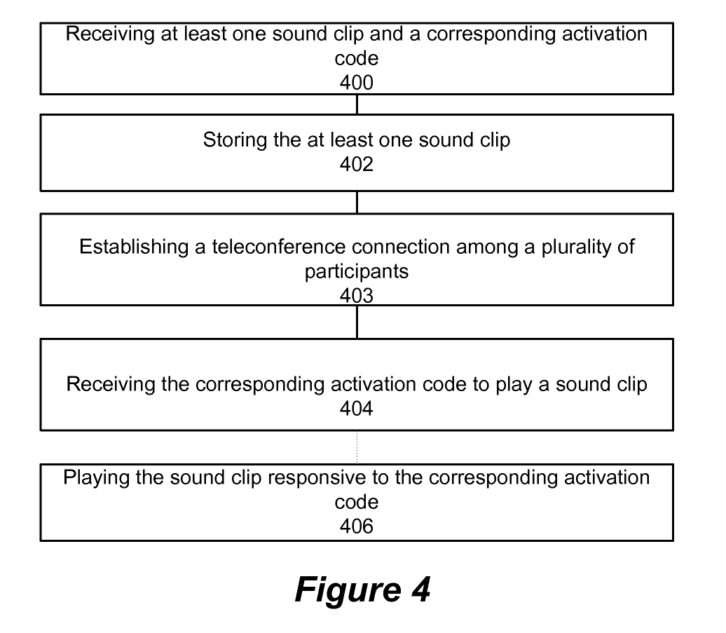

FIG. 4 illustrates and example method for enabling a user to play a sound clip during a teleconference. At step 400, a server, such as sound clip recording server 106, receives at least one sound clip and a corresponding activation code from a user. As discussed above, a user may obtain a sound clip by pre-recording a sound clip, downloading a third-party generated sound clip, generating a sound, splicing a sound clip, or the like. Once the user obtains a sound clip, the user assigns each sound clip a corresponding activation code. In one embodiment, the user then transmits the sound clip with corresponding activation code to sound clip recording server 106. In an alternate embodiment, the sound clip recording server 106 may first receive only a sound clip followed by subsequent instructions to associate a corresponding activation code to the sound clip. Conversely, the sound clip recording server 106 may receive the corresponding activation code followed by instructions associating a sound clip with the corresponding activation code.

At step 402, the sound clip recording server 106 stores at least one sound clip. Additionally, at step 402, sound clip recording server 106 may also store the corresponding activation code associated with the sound clip.

At step 403, a teleconference is established among a plurality of participants. A plurality of participants may comprise of two or more people, or it may comprise of one person and a machine.

At step 404, the sound clip recording server 106 receives the corresponding activation code to play a sound clip. At step 404, the sound clip and corresponding activation code are already stored. During a teleconference, the user then decides that s/he wants to play a particular sound clip, thus, entering the corresponding activation code on a user interface, such as user interfaces 204, 210, or 215. An activation communication is then sent to sound clip recording server 106 instructing the sound clip recording server 106 to play the sound clip. At step 404, sound clip recording server 106 receives the corresponding activation code to play a sound clip.

At step 406, the sound clip recording server 106 instructs the sound clip responsive to the corresponding activation code to play. The sound clip is audible to at least one of the plurality of participants on the teleconference. For example, the sound clip may be heard by all participants of the teleconference. In an alternate embodiment, the sound clip may only be audible to specified participants of the teleconference. Thus, the user, during a teleconference, may play a sound clip.

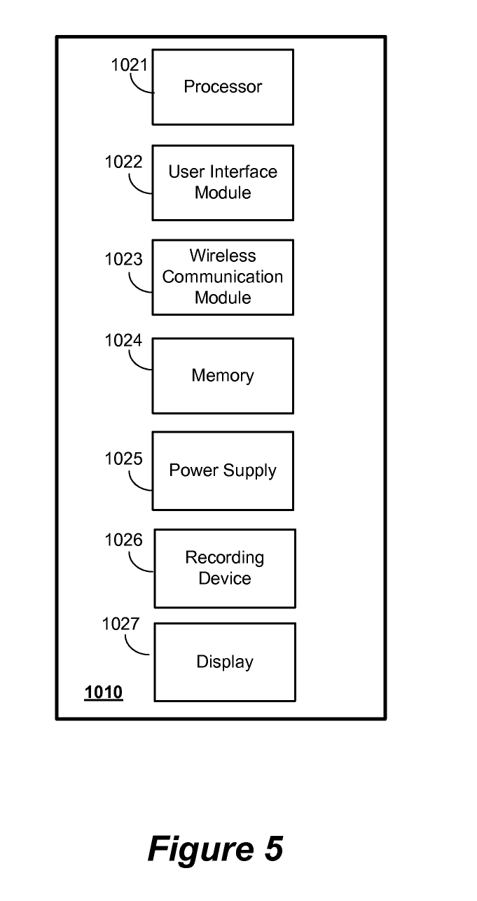

FIG. 5 illustrates an example device 1010 that may be used in connection with an embodiment. References will also be made to other figures of the present disclosure as appropriate. For example, device 102 may be a wireless device of the type described in regard to FIG. 5, and may have some, all, or none of the components and modules described in regard to FIG. 5. It will be appreciated that the components and modules of device 1010 illustrated in FIG. 5 are illustrative, and that any number and type of components and/or modules may be present in device 1010. In addition, the functions performed by any or all of the components and modules illustrated in FIG. 5 may be performed by any number of physical components. Thus, it is possible that in some embodiments the functionality of more than one component and/or module illustrated in FIG. 5 may be performed by any number or types of hardware and/or software.

Recording device 1026 may be any device capable of recording sound clips. In one embodiment, a user uses recording device 1026 to pre-record sound clips for play during a teleconference. For example, the user may use recording device 1026 for pre-recording a sound clip of a response to an anticipated question likely to be asked during a conference call. Additionally, the recording device 1026 may be located either internal or external to device 1010.

Processor 1021 may be any type of circuitry that performs operations on behalf of wireless device 1010. In one embodiment, processor 1021 executes software (i.e., computer readable instructions stored in a computer readable medium) that may include functionality related to constructing, transmitting, receiving messages such as associating a sound clip with a corresponding activation code, associating each sound clip with an identifier, and instructing a device to play a sound clip, for example. User interface module 1022 may be any type or combination of hardware and/or software that enables a user to operate and interact with wireless device 1010, in one embodiment, to compose and read messages. In another embodiment, to enter a corresponding activation code instructing a device to play a sound clip. For example, user interface module 1022 may include, physical and “soft” keys, voice recognition software, microphone, speaker and the like. Additionally, device 1010 may also comprise display 1027. Display 1027 may be any type or combination of hardware and/or software that enables a user to view the identifier of a sound clip. For example, display 1027 may include a screen, monitor, TV and the like. In one embodiment, wireless communication module 1023 may be any type or combination of hardware and/or software that enables wireless device 1010 to communicate with, for example, network 103 or any other type of wireless communications network. Storage medium 1024 enables wireless device 1010 to store information, such as sound clips, profiles, corresponding activation codes. Storage medium 1024 may take any form, such as random access memory (RAM), an SD card, a microSD card, a hard disk, a flash memory, a Compact Disc, a Digital Versatile Disc, and the like. Power supply 1025 may be a battery or other type of power input (e.g., a charging cable that is connected to an electrical outlet, etc.) that is capable of powering wireless device 1010.

The present invention has been described in connection with the preferred embodiments of the invention. Although examples have been provided, they were provided merely to assist in enhancing understanding of the invention. In no way should the present invention be limited to the examples provided herein. The present invention should not be limited to any single embodiment but instead, should be construed in breadth and scope in accordance with the appended claims.

What is claimed:

1. A method for playing a sound clip during a teleconference, comprising:
obtaining at least one sound clip;
storing the sound clip;
associating each sound clip with a corresponding activation code;
selecting the sound clip to be replayed; and
playing the sound clip by entering the corresponding activation code into a user interface during a teleconference.

2. The method of claim 1, further comprising: creating one or more profiles to store the sound clip.

3. The method of claim 2, wherein the profiles are directed to a particular teleconference, and wherein the sound clip is directed to a specified teleconference.

4. The method of claim 1, further comprising: associating each sound clip with an identifier.

5. The method of claim 4, further comprising: displaying the identifier on a display.

6. The method of claim 5, wherein the display is configured to allow a user to verify a content of the sound clip prior to playing the sound clip during a teleconference.

7. The method of claim 1, wherein obtaining the sound clip is done prior to the teleconference.

8. The method of claim 1, wherein storing the sound clip is performed using at least one of a random access memory (RAM), an SD card, a microSD card, a hard disk, a flash memory, a Compact Disc, or a Digital Versatile Disc.

9. The method of claim 1, wherein the corresponding activation code is at least one of a Dual Tone Multi Frequency tone, a Session Initiated Protocol message, a voice command, a text command, or a code.

10. The method of claim 1, wherein the user interface is a keyboard, microphone, or a touch activated screen.

11. The method of claim 1, wherein playing a sound clip is done while a user's device is muted.

12. The method of claim 1, wherein playing the sound clip is performed by dialing the Dual Tone Multi Frequency tone, sending the Session Initiated Protocol message, speaking a voice command, typing a text command, entering a code, selecting among a combination thereof.

13. The method of claim 1, wherein obtaining said sound clip comprises recording the sound clip.

14. A system for playing at least one sound clip during a teleconference, comprising:
at least one subsystem for obtaining a sound clip;
a storage medium configured to store the sound clip;
a processor configured to associate the sound clip with a corresponding activation code;
a plurality of telecommunications devices for connecting at least two or more participants via a communication network; and
a user interface configured to allow a user to input the corresponding activation code.

15. The system of claim 14, further comprising: a processor configured to associate each sound clip with an identifier.

16. The system of claim 14, wherein the storage medium is also configured to store one or more profiles created to store the sound clip, wherein the sound clip is directed to a specified teleconference.

17. The system of claim 14, further comprising: a display configured to display the identifier of the sound clip prior to instructing a device to play the sound clip during a teleconference.

18. The system of claim 14, wherein the storage medium comprises at least one of a random access memory (RAM), an SD card, a microSD card, a hard disk, a flash memory, a Compact Disc, or a Digital Versatile Disc.

19. The system of claim 14, wherein the corresponding activation signal comprises at least one of a Dual Tone Multi Frequency tone, a Session Initiated Protocol message, a voice command, a text command, or a code.

20. The system of claim 14, wherein the user interface is a keyboard, a microphone, or a touch activated screen.

21. A device for responding during a teleconference, the device comprising:
at least one subsystem for selecting at least one sound clip;
a communications component configured to connect to a communication network;
a processor configured to associate a selected sound clip to a corresponding activation code; and
a user interface configured to enter corresponding activation code.

22. The device of claim 21, further comprising: a recording component configured to record the sound clip.

23. The device of claim 21, further comprising: a processor configured to associate each selected sound clip with an identifier.

24. The device of claim 21, further comprising: a display configured to display the identifier prior to instructing the device to play the sound clip during a teleconference.

25. The device of claim 21 wherein said subsystem for selecting at least one sound clip comprises a storage medium configured to store at least one sound clip.

26. The device of claim 25, wherein the storage medium comprises at least one of a random access memory (RAM), an SD card, a microSD card, a hard disk, a flash memory, a Compact Disc, or a Digital Versatile Disc.

27. The device of claim 21, wherein the user interface is a keyboard, a microphone, or a touch activated screen.

28. A method for enabling a user to play a sound clip during a teleconference comprising:
storing at least one sound clip;
associating an activation code with each of said at least one sound clip;
establishing a teleconference connection among a plurality of participants;
receiving instructions from a user to play one of said at least one sound clip, said instructions comprising a corresponding activation code associated with the said at least one sound clip; and,
playing the sound clip responsive to said instruction wherein one of the plurality of participants are able to hear the sound clip.

29. The method in claim 28, further comprising: receiving the at least one sound clip.

30. The method in claim 28, wherein the corresponding activation code is at least one of a Dual Tone Multi Frequency tone, a Session Initiated Protocol message, a voice command, a text command, or a code.
